(19) United States
(12) Patent Application Publication
(10) Pub. No.: US 2008/0187056 A1
(43) Pub. Date: Aug. 7, 2008

(54) HYBRID CIRCUIT USING RESISTOR

(76) Inventors: Kohtaroh GOTOH, Kawasaki (JP); Hirotaka Tamura, Kawasaki (JP)

Correspondence Address: ARENT FOX LLP, 1050 CONNECTICUT AVENUE, N.W., SUITE 400, WASHINGTON, DC, 20036, US

(21) Appl. No.: 12/048,946

(22) Filed: Mar. 14, 2008

Related U.S. Application Data
(63) Continuation of application No. PCT/JP2005/017072, filed on Sep. 15, 2005.

(51) Int. Cl. H04B 3/00; H04L 23/00

(52) U.S. Cl. 375/257; 375/377

(57) ABSTRACT

A hybrid circuit includes a resistor inserted serially between a transmission line and an output driver for transmitting a signal; and a reception signal extraction unit for extracting only a reception signal from a signal existing in a transmission path by using a signal obtained from both ends of the resistor. The reception signal extraction unit can be constituted by, for example, two transconductance amplifiers for converting the input voltage into a current and a load resistor in which flows the current of a result of adding the output currents of the two amplifiers.

### CROSS REFERENCE TO RELATED APPLICATION

This application is a continuation of PCT application PCT/JP2005/017072, which was filed on Sep. 15, 2005, and the entire contents of which are incorporated herein by reference.

### BACKGROUND OF THE INVENTION

1. Field of the Invention

The present invention relates to a transmission method for a high-speed signal between a plurality of elements or circuit blocks between LSI chips or within the same LSI chip, between boards or between chassis, and specifically to a hybrid circuit that is used for a signal transmission system for transmitting a high-speed signal bi-directionally in order to extract only a reception signal (i.e., received signal) from a signal, in which a transmission signal is superimposed on the reception signal, in a transmission path.

2. Description of the Related Art

Recent years have witnessed significant improvements in the performance of components constituting computers and other information processing apparatuses, as seen, for example, in semiconductor storage apparatuses, such as dynamic random access memory (DRAM), and processors whose improvements in performance have been remarkable. In association with the performance improvements of the semiconductor storage apparatuses, processors and the like, a situation arises where an improvement in system performance is not possible unless the signal transmission speed between respective components or elements is improved. To give a specific example, the signal transmission speed between a main storage apparatus, such as DRAM, and a processor is increasingly becoming an obstacle to the performance improvement of the entire computer. Further, it is increasingly necessary to improve signal transmission speed not only for the signal transmission between chassis or between boards (i.e., printed circuit boards), such as that between a server and a main storage apparatus and between servers communicating by way of a network, but also for the signal transmissions between large scale integration (LSI) chips, between elements and/or between circuit blocks within the same chip, all of which are required in association with the higher integration, larger scales, and the like, of semiconductor chips. Further, in the signal transmissions between the boards, between chassis or between a plurality of elements and/or circuit blocks between LSI chips or within the same chip, what is required is a reduction in the number of signal lines, wiring patterns and the like, thereby improving the usage efficiency of a transmission path. Further, the provision of signal transmission systems, signal transmission methods, and transceiver circuits which are capable of transmitting high-speed signals bi-directionally at a greater accuracy is being demanded.

The data rate of signal transmission and reception internally in, and externally to, an apparatus needs to be improved in proportion to the performance improvement of a backbone trunk line telecommunication-use apparatus, an information processing device such as a server, and the like. In the case of the communication between the processors in a multi-processor server, a bi-directional communication takes place in the link and therefore a bi-directional signal transmission transmitting signals simultaneously and bi-directionally in a cable provides a greater benefit.

In order to carry out a simultaneous bi-directional signal transmission, a so-called hybrid circuit separating the up- and down-link signals is required. The hybrid circuit includes a hybrid transformer (after which the hybrid circuit was named) used for a voice band of a public telephone network, and a resistor hybrid in an unshielded twisted pair (UTP)-5-use Ethernet technology, such as 100 Base-T and the like. Further, as the data rate has entered the gigabit-per-second region, a hybrid circuit using a replica driver has been used.

FIG. 1 is a diagram describing a conventional example of a signal transmission system using a resistor hybrid. Referring to FIG. 1, an example is given of a 50-ohm resistor 103 equivalent to the characteristic impedance Z₀ of a transmission line 100 being inserted between a bi-directional transmission line 100 and an output driver 101 for transmitting a signal. Further, two resistors 102 possessing the same resistance value R are connected in series between the ground and a connection point of an output driver 101 to a resistor 103 and an amplifier 104 is also equipped in the system of FIG. 1. The voltage at the connection point of the transmission line 100 connected to the resistor 103 and the voltage at the connection point between the two resistors 102 are input into the amplifier 104. Further, the characteristic impedance of the transmission line 100, that is, a 50-ohm resistor, is connected between the output terminal of the transmission line 100 and the ground for an impedance matching. Note that this system is a bi-directional transmission system in which another output driver for also outputting a signal is connected to the output side of the transmission line 100, that is, connected on the corresponding side of a communication.

In FIG. 1, the voltage of a transmission signal as the output of the output driver 101 is divided by the two resistors 102 and the half value of a transmission signal voltage is given to the inverting input terminal of the amplifier 104. This is equivalent to the fact that the output voltage of the output driver 101 is divided simultaneously by the resistor 103 and the impedance matching-use resistor on the output side of the transmission line 100, and by providing the non-inverting input terminal of the amplifier 104 with the voltage at the connection point where the transmission line 100 is connected to resistor 103, half of the voltage of the transmission signal is subtracted from the voltage at the connection point where the transmission line 100 is connected to the resistor 103, that is, the voltage in which half of the voltage of the transmission signal is superimposed on reception voltage, resulting in outputting the amplification result of the reception signal from the amplifier 104. Note that the resistance value of the resistor 102, that is, R, is assumed to be far larger than 50 ohms.

In the hybrid circuit using the resistor hybrid described for FIG. 1, however, the impedance of the output driver needs to be lowered. A feedback operation or the like for the output driver is employed in an attempt to lower the impedance of the output driver. The speed of the signal output from the output driver, however, is limited to several hundred MHz or less for attaining a low impedance by such feedback operation, ushering in the problem of an inability to use the technique for high-speed data transmission.

FIG. 2 is a conventional example of a hybrid circuit using a replica driver.

Referring to FIG. 2, output drivers 101 for a bi-directional data transmission are respectively connected to both sides of a bi-directional transmission line 100. The configurations of both sides of the transmission line 100 are basically the same, on the left side of which, for example, a transmission signal Tx1 is given to an output driver 101 and a replica driver 107. Here, the replica driver 107 is a replica that is smaller in size than the output driver 101. Then, the output signal of the replica driver 107 is subtracted, by a subtracter 108, from the signal at the connection point between the transmission line 100 and the output driver 101. That is, a transmission signal as the output of the replica driver 107 is subtracted from the signal, existing in the transmission path, which superimposes the transmission signal on the reception signal, resulting in outputting a reception signal Rx1 from the subtracter 108.

The hybrid circuit using such a replica driver, however, ushers in the problems. First problem is the power consumption of the replica driver and an increase in circuit size. Second, a highly accurate timing design is required for exactly matching, in a circuit using the replica driver, the timing of the output signal output from the replica driver with that of the signal in the transmission path, that is, with the timing of the signal at the connection point of the transmission line 100 to the output driver 101, regardless of whether the communication method is a continuous time or a discrete time, ushering in a difficulty in speeding up, for example, to 5 gigabits per second or more.

### SUMMARY OF THE INVENTION

A hybrid circuit according to an aspect of the present invention is one for separating, from a transmission signal, a reception signal transmitted from the corresponding party of a telecommunication in a bi-directional signal transmission system, comprising: a resistor being inserted serially between a transmission line and an output driver for transmitting a signal to the corresponding party; and a reception signal extraction unit for extracting only a reception signal from a signal existing in the transmission line by using a signal obtained from both ends of the resistor.

### BRIEF DESCRIPTION OF THE DRAWINGS

FIG. 1 is a descriptive diagram of a conventional example of a resistor hybrid;

FIG. 2 is a descriptive diagram of a conventional example of a hybrid circuit using a replica driver;

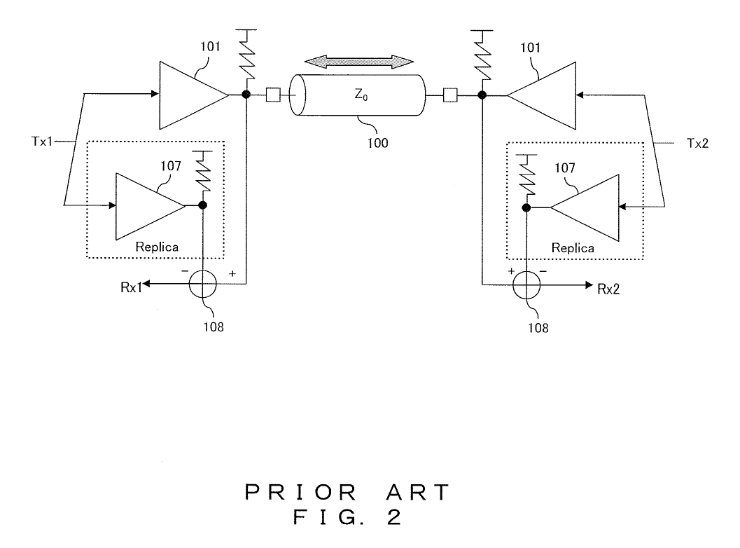

FIG. 3 is a configuration block diagram showing the principle of a hybrid circuit using a resistor according to embodiments of the present invention;

FIG. 4 is the fundamental configuration block diagram of a data transmission/reception apparatus using a hybrid circuit according to an embodiment of the present invention;

FIG. 5 is a diagram describing the fundamental configuration of a bi-directional data transmission system using a hybrid circuit according to an embodiment of the present invention;

FIG. 6 is a descriptive diagram of the fundamental configuration of a hybrid circuit according to an embodiment of the present invention;

FIG. 7 is a descriptive diagram of a first preferred embodiment of the present invention;

FIG. 8 is a descriptive diagram of a second preferred embodiment of the present invention;

FIG. 9 is a descriptive diagram of a third preferred embodiment of the present invention;

FIG. 10 is a descriptive diagram of a fourth preferred embodiment of the present invention;

FIG. 11 is a descriptive diagram of a fifth preferred embodiment of the present invention;

FIG. 12 is a descriptive diagram of a sixth preferred embodiment of the present invention;

FIG. 13 is a circuit diagram showing a detailed configuration of a hybrid circuit corresponding to the sixth preferred embodiment; and

FIG. 14 is a diagram describing the result of a simulation for an embodiment of the present invention.

### DESCRIPTION OF THE EMBODIMENTS

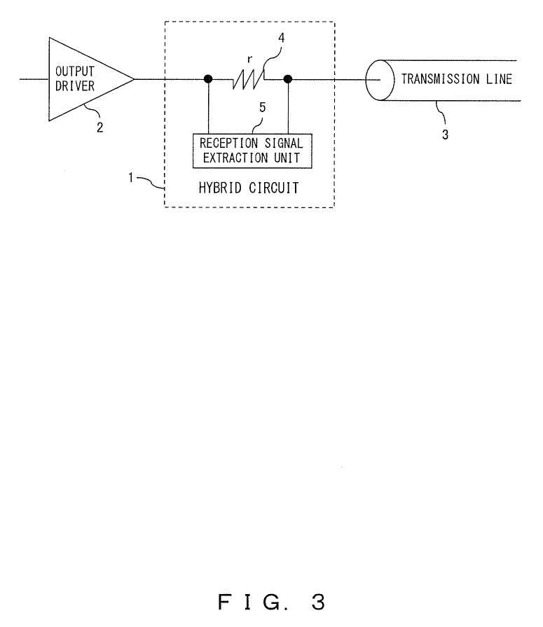

FIG. 3 is a diagram describing the principle applied in embodiments of the present invention. Referring to FIG. 3, a hybrid circuit 1 using a resistor includes a resistor 4 (r) equipped between a transmission line 3 and the output driver 2 of a transmitter and which is connected between the transmission line 3 and output driver 2, and includes a reception signal extraction unit 5 connected to both ends of the resistor 4. The reception signal extraction unit 5 is for extracting a reception signal separately from a transmission signal by using the signal obtained from both ends of the resistor 4.

An embodiment of the present invention may also be configured such that the reception signal extraction unit includes a first voltage amplifier for amplifying the voltage across both ends of the resistor 4, a second voltage amplifier for amplifying the voltage at the connection point of the resistor 4 to the transmission line 3, and an adder for adding the outputs of the first and second voltage amplifiers.

The configuration in this case may also be such that the amplification factor of the first voltage amplifier is Z₀/r and that of the second voltage amplifier is “1”, where the impedance of the transmission line is Z₀, and the adder outputs a voltage that is two times a reception signal voltage Vᵣ.

An alternative configuration may be such that the amplification factor of the first voltage amplifier is gₘZ₀/r and that of the second voltage amplifier is gₘ, where gₘ is a constant, and the adder outputs a voltage that is 2 gₘ times a reception signal voltage Vᵣ.

Another embodiment of the present invention may also be configured such that the transmission line is that of a pair of differential signals and resistors r are respectively inserted into the respective same positions in the transmission paths of the differential signals, that is, between the output driver and transmission line; and the reception signal extraction unit includes a first voltage amplifier for amplifying the difference between the voltage at the connection point of the transmission line to the resistor r in the transmission path of a non-inverting signal of the differential signal and the voltage at the same connection point in the transmission path of an inverting signal, a second voltage amplifier for amplifying the difference between the voltage at the connection point of the output driver to the resistor r in the transmission path of the non-inverting signal and the voltage at the same connection point in the transmission path of the inverting signal, and an adder for adding the outputs of the first and second voltage amplifiers.

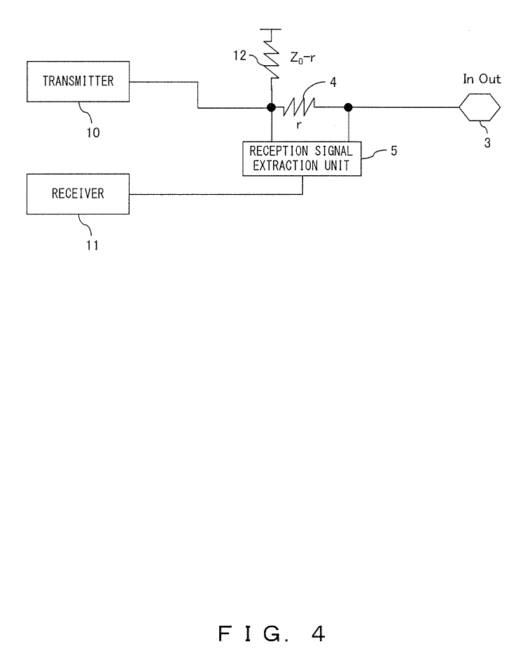

Next is a detailed description of the preferred embodiments of the present invention by referring to FIG. 4 and thereafter. FIG. 4 is the overall system configuration diagram of a data transmission/reception apparatus on one side of a transmission line of a bi-directional data transmission system. Referring to FIG. 4, a transmitter 10 including the output driver 2 of FIG. 3 is connected to the transmission line 3 by way of the resistor 4 (r). Further, the reception signal extraction unit 5 connected to both ends of the resistor 4 is connected to a receiver 11. Note that, in this example, a resistor 12 possessing the value of Z₀−r is connected between the output terminal of the transmitter 10 and the power supply voltage so that the impedance, when viewed from the transmission line 3 to the transmitter 10, matches with the characteristic impedance Z₀ of the transmission line 3. As described later in detail, this corresponds to the case of the impedance of the output driver 2 of FIG. 3 being large.

Although there is no direct relationship with the context of embodiments of the present invention, the transmitter 10 may be for converting a, for example, 64-bit parallel signal into 4-bit parallel data by way of, for example, a multiplexer, then converting the 4-bit parallel data into serial data and outputting it to the transmission line 3 by way of the output driver2. In contrast, the receiver 11 may be for equalizing the received serial signal by way of an equalizer, then converting the equalized signal into, for example, 32-bit parallel data by way of a demultiplexer and using it for necessary data processing. Note that the resistor 12, in addition to the resistor 4 and reception signal extraction unit 5, can also be considered to be a part of the hybrid circuit shown in FIG. 4.

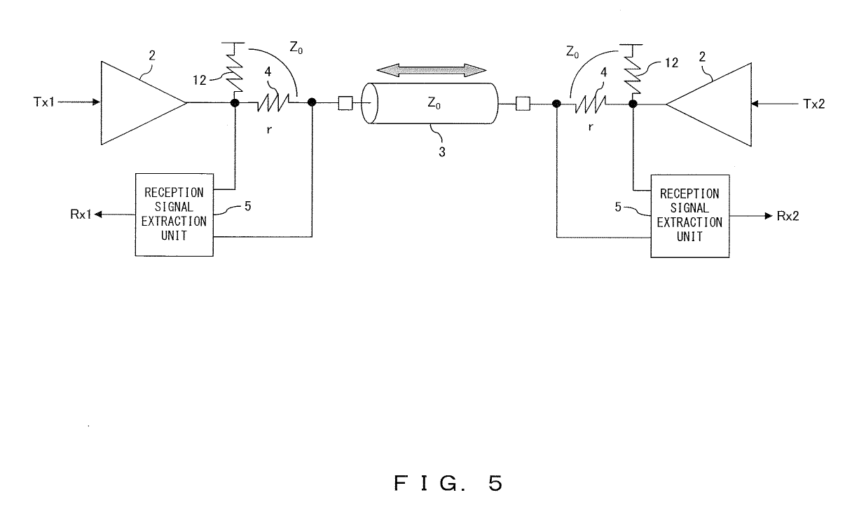

FIG. 5 is a block diagram of the overall configuration of a bi-directional data transmission system using a hybrid circuit according to an embodiment of the present invention. Each side of the transmission line 3 is equipped with a hybrid circuit including an output driver 2 included in the transceiver for carrying out a data transmission to the corresponding party of a telecommunication, a resistor 4, a reception signal extraction unit 5 and a resistor 12, with the reception signal extraction unit 5 of the hybrid circuit outputting a reception signal (Rx1 or Rx2) transmitted from the corresponding party of a telecommunication. Note that, when viewed from one end of a bi-directional transmission line, the phrase “the corresponding party of a telecommunication”, which can be paraphrased as “the other party of a telecommunication”, is intended to mean a device or system at the other end of a bi-directional transmission line. That is, the corresponding party of a telecommunication is a destination for data that is to be transmitted and also a source of received data in a bi-directional telecommunication.

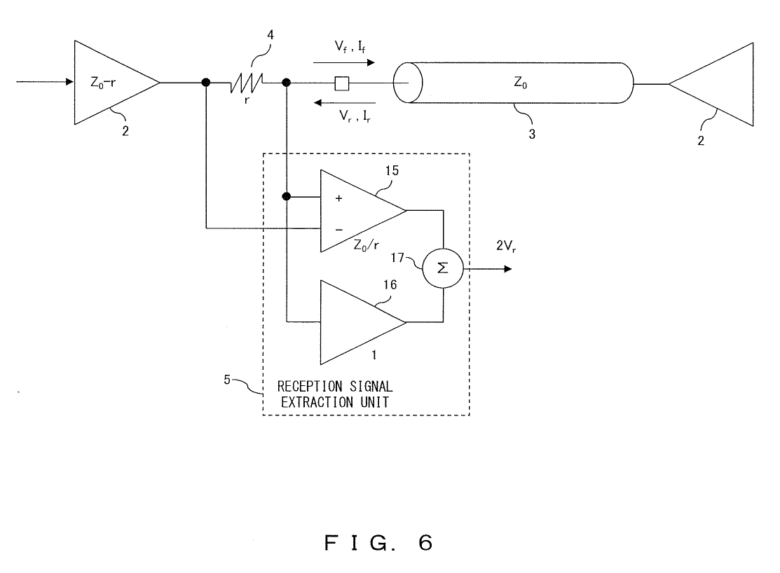

FIG. 6 is a descriptive diagram of the fundamental configuration of the reception signal extraction unit shown in FIG. 3. Referring to FIG. 6, the reception signal extraction unit 5 includes an amplifier 15 for amplifying the difference in potential of both ends of the resistor 4, an amplifier 16 for amplifying the voltage at the connection point of the resistor 4 to the transmission line 3, and an adder 17 for adding the outputs of the two amplifiers 15 and 16.

The impedance of the output driver needs to be Z₀−r so that the impedance, viewed from the transmission line 3 to the output driver 2 of the inside of the transmitter, matches with the characteristic impedance Z₀ of the transmission line in order to prevent the reflection of a reception signal or a similar problem; it is actually, however, very difficult to reduce the impedance of the high-speed signal transmission-use output driver 2 further than a certain extent as described above. Therefore, if the impedance of the output driver 2 is large, the resistor 12 may be connected between the power supply voltage and output point of the output driver 2 as described for FIG. 4. Here, the reason for connecting the resistor 12 between the power supply voltage and the output point of the output driver 2 is that the actual circuit configuration, as described later, is such that transconductance amplifiers corresponding to the two amplifiers 15 and 16 and adder 17, which are shown in FIG. 6 as an example, are constituted by, for example, CMOS elements, and that the power supply voltage is selected as an appropriate connection point of the resistor 12 in such a configuration.

Where the transmission voltage and transmission current by way of the output driver 2 are respectively defined as V_{f} and I_{f} at the connection point of the transmission line 3 to the resistor 4, and the reception voltage and reception current that are transmitted from the corresponding party of a telecommunication are respectively defined as Vᵣ and Iᵣ, then the voltage V and current I at the connection point of the resistor 4 to the transmission line 3 are respectively given by the following expressions:

V=V_{f}+Vᵣ

I=I_{f}−Iᵣ=(V_{f}−Vᵣ)/Z₀

On the basis of these expressions, the reception voltage Vᵣ is given by the following expression:

Vᵣ=(V−Z₀I)/2

Here, the input voltage to the amplifier 15 is −rI, the input voltage to the amplifier 16 is V, and an addition of the output voltages of two amplifiers 15 and 16 obtains 2Vᵣ. It makes the output of the adder 17 depend only upon the reception voltage Vᵣ, thereby making it possible to extract a reception signal voltage separately from the transmission signal.

As described above, the embodiment of the present invention is contrived to enable the extraction of only a reception signal, without using a replica driver, separately from signals existing in the line where a transmission signal is superimposed on a reception signal. This capability makes it possible to reduce the required power and area size that would have gone for the replica driver, and to eliminate the need for a timing adjustment when subtracting the output voltage of the replica driver from the signal existing in the transmission line, thereby facilitating a speed-up of the signal transmission.

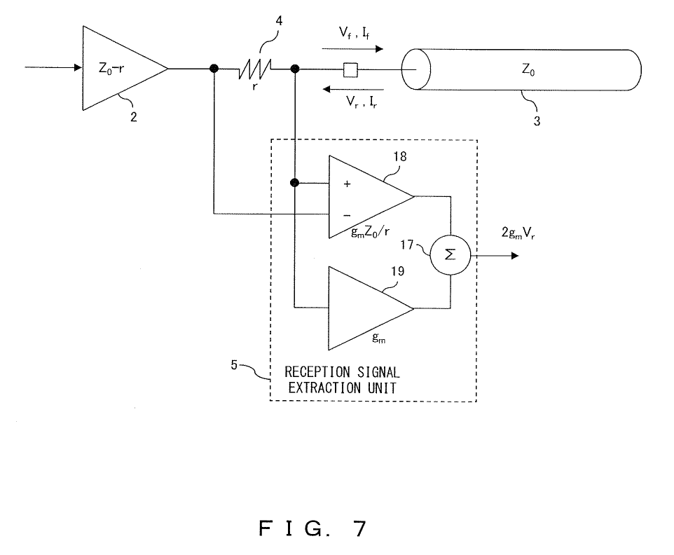

FIG. 7 is a diagram of the fundamental configuration of a first preferred embodiment of the present invention. Comparing FIG. 7 with FIG. 6, the difference is that the gains of two amplifiers 18 and 19 at the inside of the reception signal extraction unit 5 are respectively gₘ times the gains of the amplifiers 15 and 16 that are shown in FIG. 6. In the actual circuit configuration as described later, the use of a circuit that employs two transconductors (i.e., transconductance amplifiers), being equivalent to the two voltage amplifiers, for converting the input voltage into current and that adds the currents output from the two transconductors makes it easier to configure the circuit than the use of two voltage amplifiers and an adder as shown in FIG. 7. Note that the gₘ is a constant equivalent to the value of the transconductance of the transconductor. Thus, the adder 17 outputs the voltage of 2 gₘ times the reception voltage Vᵣ.

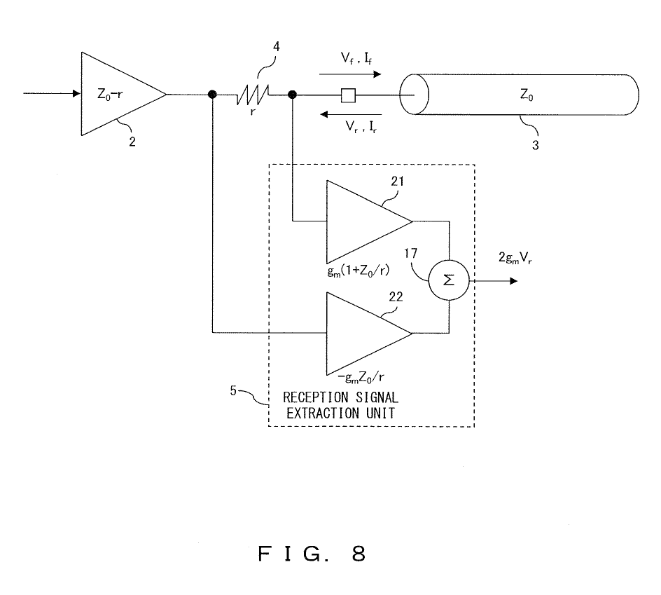

FIG. 8 is a descriptive diagram of the fundamentals of a second preferred embodiment of the present invention.

Referring to FIG. 8, the reception signal extraction unit 5 includes an amplifier 21 of which the gain is gₘ(1+Z₀/r), an amplifier 22 of which the gain is −gₘZ₀/r, and an adder 17 for adding the outputs of the two amplifiers.

Referring to FIG. 8, the input voltage of the amplifier 21 is V, and that of the amplifier 22 is V+Ir. The addition of the outputs of the amplifiers 21 and 22 for these inputs makes the output of the adder 17 be 2 gₘ times the reception voltage Vᵣ, as in the case of the first embodiment.

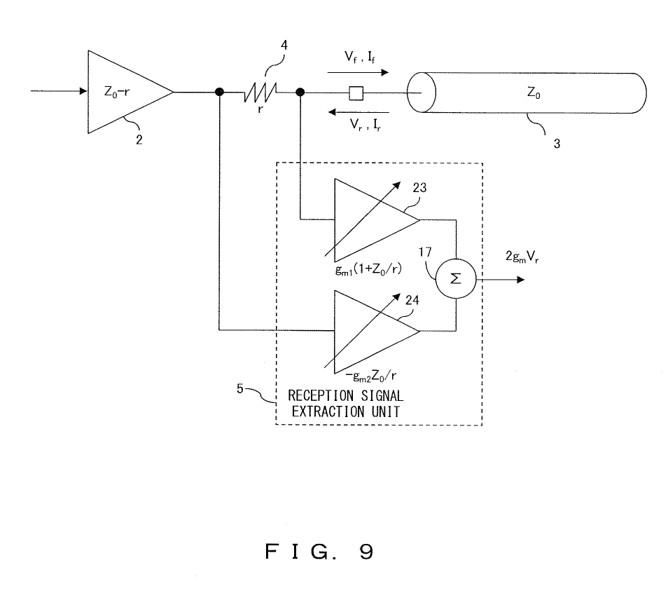

FIG. 9 is a descriptive diagram of the fundamentals of a third preferred embodiment of the present invention. Referring to FIG. 9, the essentials of the configuration of the reception signal extraction unit 5 are similar to those of the second embodiment described for FIG. 8; the difference lies in that the values of gₘ₁ and gₘ₂, which are equivalent to the transconductance of the transconductors, are configured to be variable among factors defining the gains of the two voltage amplifiers 23 and 24.

In general, the gain of a voltage amplifier or a transconductance amplifier utilized for the actual circuit, is varied by, for example, a process fluctuation, and therefore an adjustment of both of the gains of the two voltage amplifiers 23 and 24, or only either one of them, and a compensation of the variation so that the values of the transconductance match with each other as described for the second embodiment make it possible to compensate for a deterioration of the reception signal detection sensitivity due to a variation in the amplifiers. This results in the adder 17 outputting a voltage defined by the value of the matched transconductance as a result of compensating for the variation.

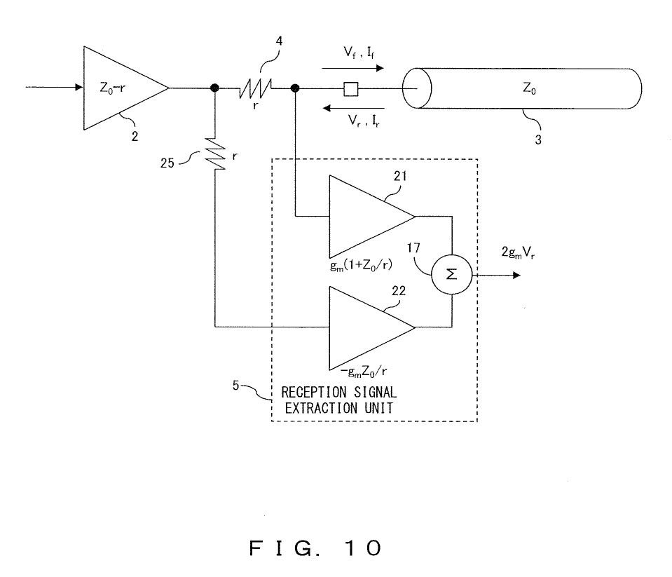

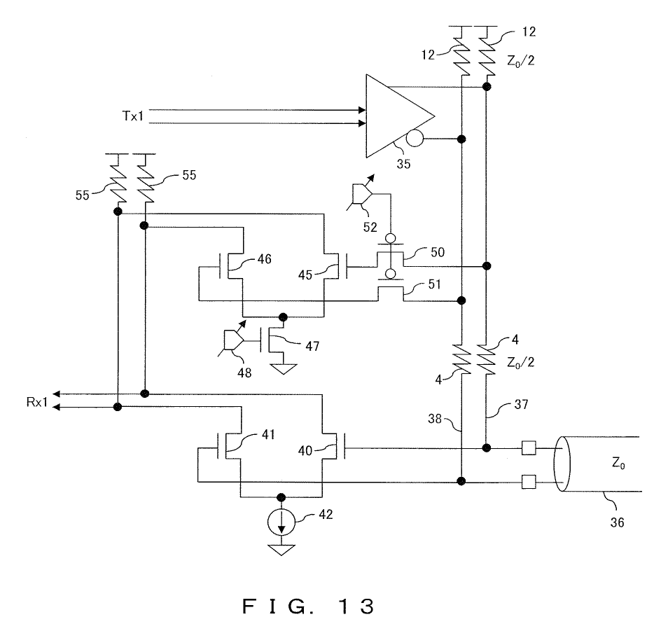

FIG. 10 is a descriptive diagram of the fundamentals of a fourth preferred embodiment. Referring to FIG. 10, the configuration of the reception signal extraction unit 5 is the same as that of the second embodiment shown in FIG. 8. The difference from the second embodiment is that a resistor 25 is inserted between the voltage amplifier 22 and the connection point of the output driver 2 to the resistor 4 in the fourth embodiment. The resistor 25 is configured to possess the same resistance value r as that of the resistor 4 so that the insertion of the resistor 25 makes it possible to have the time constants of the respective inputs into the two voltage amplifiers 21 and 22 (i.e., equivalent to transconductance amplifiers) approach being identical. That is, the resistor 25 is inserted to make the input time constants, each of which is defined as the product of [a] and [b], where [a] is each respective impedance when viewing the signal source from each respective input terminal of the two voltage amplifiers 21 and 22 and [b] is each respective input capacitance of each respective voltage amplifiers 21 and 22, be close to the same between the two voltage amplifiers 21 and 22, details of which are further described later by referring to FIG. 13.

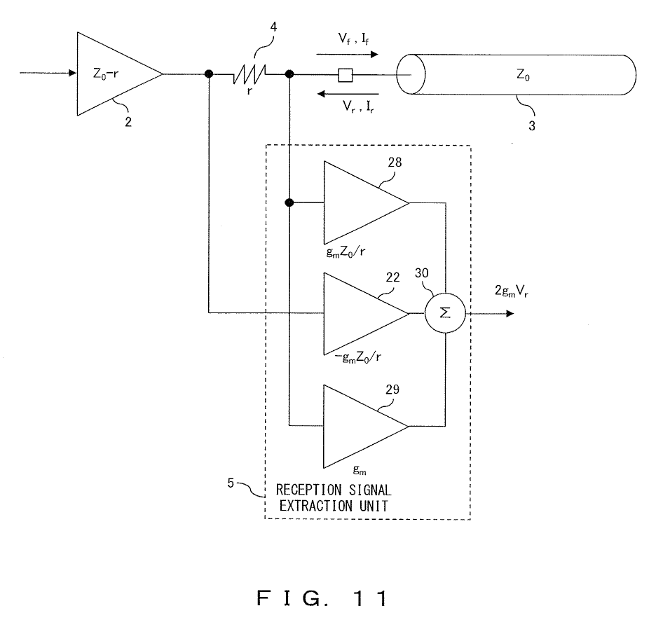

FIG. 11 is a descriptive diagram of the fundamentals of a fifth preferred embodiment of the present invention. Referring to FIG. 11, the reception signal extraction unit 5 includes an amplifier 28 with a gain of gₘZ₀/r, an amplifier 22 with a gain of −gₘZ₀/r, an amplifier 29 with a gain of gₘ, and an adder 30 for adding the outputs of the three amplifiers. The inputs to the voltage amplifiers 28 and 29 are V, the input to the voltage amplifier 22 is V+Ir, and the addition of outputs of the three voltage amplifiers obtains an addition result equivalent to that in the case of the first and second embodiments.

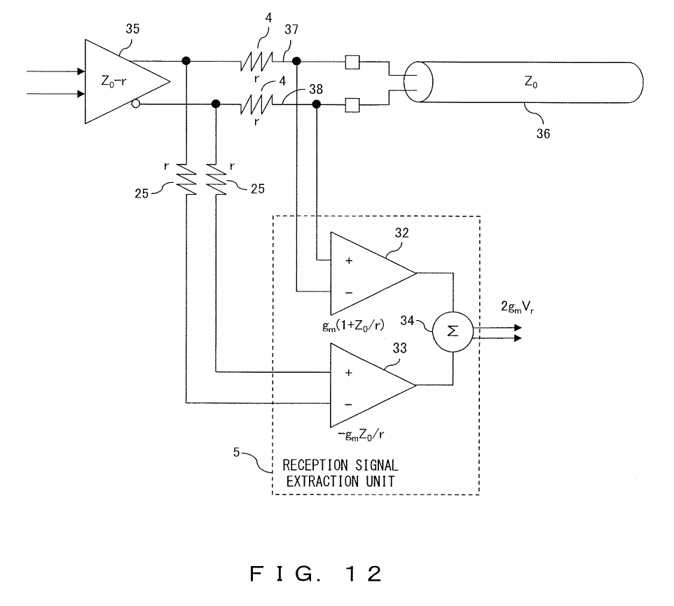

FIG. 12 is a descriptive diagram of the fundamentals of a sixth preferred embodiment of the present invention. The sixth embodiment is configured to carry out the operation of extracting only a reception differential signal from signals existing in a transmission line if a pair of differential signals is bi-directionally transmitted by way of the transmission line.

Referring to FIG. 12, the output driver 35 outputs a pair of differential signals that is to be transmitted to the corresponding party of a telecommunication, to the transmission line 37 for a non-inverting signal and to the transmission line 38 for an inverting signal. Then, the differential signals are transmitted to the corresponding party by way of the transmission line 36 for differential signals. A reception signal received from the corresponding party is superimposed on the non-inverting signal transmission line 37 and inverting signal transmission line 38, in which two voltage amplifiers 32 and 33 are made to input the voltages on the non-inverting signal transmission line 37 and inverting signal transmission line 38, where, for example, the transmission voltage on the non-inverting signal transmission line 37 is expressed as V_{f}/2 and the reception voltage thereon is expressed as Vᵣ/2, and the outputs of the two voltage amplifiers 32 and 33 are added by the adder 34, and thereby a differential voltage signal of 2 gₘ times the reception voltage Vᵣ is output from the reception signal extraction unit 5 as in the case of the first embodiment shown in FIG. 7. Further, the sixth embodiment is also configured to insert the resistors 25 respectively between each connection point of the output driver 35 to the resistor 4 and each of the two input terminals of the voltage amplifier 33, as in the case of the fourth embodiment shown in FIG. 10. The insertion of the resistors is also for equalizing, as much as possible, the input time constant for the two voltage amplifiers 32 and 33, as described for the fourth embodiment.

FIG. 13 is a diagram showing a detailed configuration of a hybrid circuit on one side of the transmission line, including an output driver, and this corresponds to the sixth embodiment shown in FIG. 12. In the case of FIG. 13, the differential signals output from the output driver 35 are input into the transmission line 36 by way of the non-inverting signal transmission line 37 and inverting signal transmission line 38 and transmitted to the corresponding party of a telecommunication, as in the case of FIG. 12.

Referring to FIG. 13, the voltages at the connection points of the resistors 4 to the transmission line 36 respectively on the non-inverting signal transmission line 37 and inverting signal transmission line 38 are input into a first transconductance amplifier, which is equivalent to the voltage amplifier 32 shown in FIG. 12. The first transconductance amplifier, including nMOS transistors 40 and 41 and a current source 42, is for converting the input voltage into a current and giving it to two load resistors 55.

The voltages of the connection points where the output driver 35 is connected to each respective resistors 4 respectively on the transmission lines 37 and 38 are input into a second transconductance amplifier that includes three nMOS transistors 45 through 47 and a variable voltage source 48 and that is equivalent to the voltage amplifier 33 shown in FIG. 12. The second transconductance amplifier is also for converting the input voltage into a current and giving the current to the two load resistors 55, as with the first transconductance amplifier. Thus, the currents of the two transconductance amplifiers are added and flow through the two load resistors 55 so that an operation equivalent to the add operation performed by the adder 34 shown in FIG. 12 is performed.

As described above, the use of the CMOS differential pair as a transconductance amplifier attains a high-speed operation. Further, the use of a constant current driver, as an output driver, suitable to a high-speed operation enables a high-speed operation of no less than, for example, 10 gigabits per second.

The p-type MOS transistors 50 and 51, which are respectively inserted between the respective connection points, in each of which the output driver 35 is connected to each resistor 4, and the respective gates of the n-type MOS transistors 45 and 46, are equivalent to the resistors 25 shown in FIG. 12. The value of the equivalent resistance of the p-type MOS transistors 50 and 51 is controlled by the gate voltage output from the variable voltage source 52.

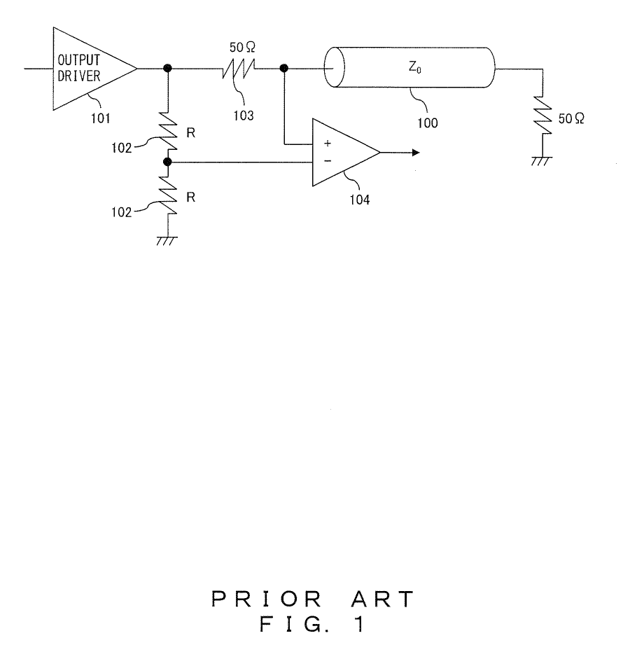

Next is a description of the impedance when viewing the signal source from the input terminals of the two transconductance amplifiers. First, the impedance when viewing the signal source from the respective gates of the transistors 40 and 41 is Z₀/2 that is a parallel impedance of the value Z₀ of the resistor connected between the output terminal of the transmission line 36 and the ground for impedance matching, as described for FIG. 1 and the combined resistance (Z₀) of the resistor 4 and resistor 12 which are connected in series.

In contrast, the impedance when viewing the signal source from the gates of the n-type transistors 45 and 46 when the p-type transistors 50 and 51 do not exist is the value of a parallel connection of resistors between the resistor 12, that is, Z₀/2 and 3Z₀/2, as the sum of the resistor 4 and the impedance matching-use resistor at the output terminal of the transmission line 36, and hence the resultant value is 3Z₀/8.

Meanwhile, the amplification factor of the voltage amplifier 32 shown in FIG. 12, that is, the magnitude of the transconductance of the first transconductance amplifier shown in FIG. 13 is 3 gₘ, and the amplification factor of the voltage amplifier 33, that is, the magnitude of the transconductance of the second transconductance amplifier shown in FIG. 13, is 2 gₘ. The input capacitance of a transconductance amplifier is proportional to the magnitude of transconductance and therefore, if the input capacitance of the first transconductance amplifier is 3C, then that of the second transconductance amplifier is 2C.

Therefore, when the p-type transistors 50 and 51 are not inserted, the input time constant of the first transconductance amplifier is 3CZ₀/2 and that of the second transconductance amplifier is 3CZ₀/4, with the result that the time constant of the second transconductance amplifier is one half that of the first transconductance amplifier. The resistors 25 need to be inserted, as described for FIG. 12, in order to correct the difference in these time constants. The input time constant of the second transconductance amplifier is 7CZ₀/4 if the resistance value of the resistor 25 is Z₀/2. In order to further bring the input time constants of the two transconductance amplifiers closer to each other, the gate voltages of the two p-type transistors 50 and 51 are adjusted. This configuration makes it possible to improve the reception sensitivity of the reception signal.

In FIG. 13, the configuration of the hybrid circuit fundamentally including two transconductance amplifiers and load resistors for use in a bi-directional transmission system for differential signals has been described in detail. It is of course possible to configure a hybrid circuit by using two transconductance amplifiers and a load resistor in place of, for example, the two voltage amplifiers 18 and 19 and adder 17 in the configuration of FIG. 7 showing the first embodiment.

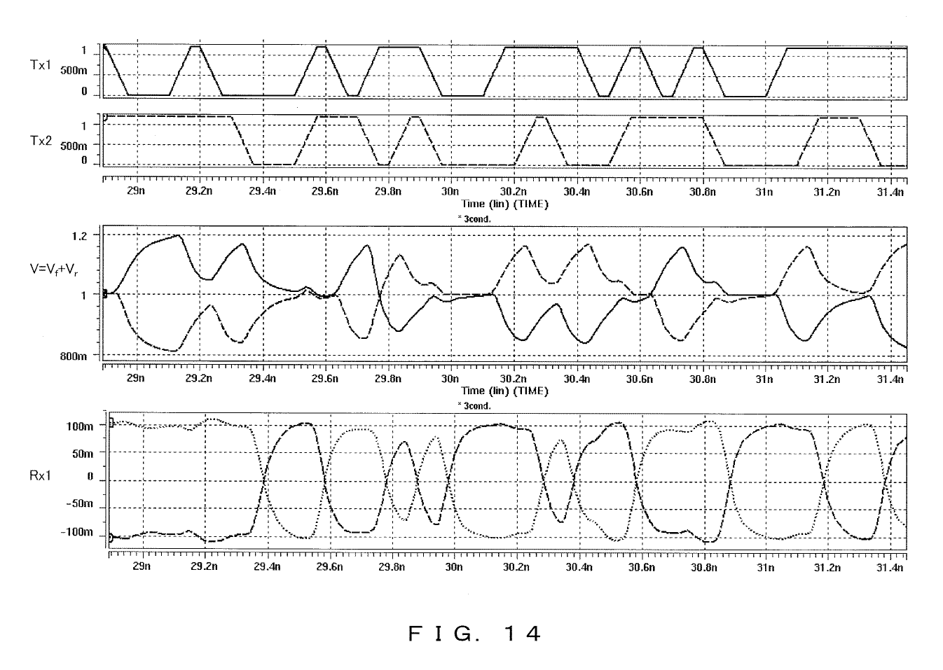

Lastly, a description of a simulation result of extracting a reception signal by using the hybrid circuit according to an embodiment of the present invention is provided by referring to FIG. 14. In FIG. 14, two signals Tx1 and Tx2 on the upper rows indicate the waveforms of transmission signals sent to the corresponding party of a telecommunication by way of the bi-directional transmission line 3 as shown in FIG. 5. Note that the waveforms, as an example, indicate non-inverting signals of the differential signals.

The signal V on the center is the voltage

V=V_{f}+Vᵣ

at the connection point of the resistor 4 to the transmission line 3 as described for FIG. 6. The signal V indicates a differential voltage signal in which a transmission differential signal is super imposed on a reception differential signal.

The signal Rx1 on the lowest row in the drawing is a result of extracting a reception signal output from the reception signal extraction unit 5 in FIG. 5, showing a pair of reception differential signals when only a reception signal is extracted from the voltage waveform V on the center, that is, from the signal in which the transmission signal is superimposed on the reception signal. This makes it comprehensible that the pair of reception differential signals is correctly extracted as inverted signals in the up and down directions.

Note that this simulation has been carried out on the assumption that the transmission line is wiring on a printed circuit board of 20 cm in length with a signal loss of 5 dB and that the transmission data as a pseudo-random signal is sent from both ends of the transmission line by way of a transmitter. The amplitude of the signal is 200 mV p-p varying between 1 volt to 1.2 volts when sending a signal from the transmitter on only one side. Because the signals from both sides are superimposed, the amplitude is actually 400 mV p-p varying between 800 millivolts and 1.2 volts, as shown in the waveform on the center.

As described above in detail, embodiments of the present invention are contrived to enable the extraction of a reception signal separately from a signal existing in a transmission path, that is, the signal in which a transmission signal is superimposed on the reception signal without using a replica driver. This in turn makes it possible to reduce the power and area required when using the replica driver and eliminates the need for a timing control for the output voltage of the replica driver and a signal existing in the transmission path, and thereby a speed of no less than one gigabit per second is easily attained in a bi-directional data transmission system and this greatly contributes to the performance improvement in signal transmission and reception in telecommunication institute-use apparatuses, information processing apparatuses such as servers, etc.

What is claimed is:

1. A hybrid circuit for separating, from a transmission signal, a reception signal transmitted from a corresponding party of a telecommunication in a bi-directional signal transmission system, comprising:
a first resistor inserted serially between a transmission line and an output driver for transmitting a signal; and
a reception signal extraction unit for extracting only a reception signal from a signal existing in the transmission line by using a signal obtained from both ends of the first resistor.

2. The hybrid circuit according to claim 1, wherein
the reception signal extraction unit comprises
a first voltage amplifier for amplifying the voltage across both ends of the first resistor,
a second voltage amplifier for amplifying the voltage of a connection point where the first resistor is connected to the transmission line, and
an adder for adding outputs of the first and second voltage amplifiers.

3. The hybrid circuit according to claim 2, wherein
the amplification factor of the first voltage amplifier is Z₀/r,
the amplification factor of the second voltage amplifier is 1, and
the adder outputs a voltage of two times a reception signal voltage Vᵣ, where the characteristic impedance of the transmission line is Z₀ and the resistance value of the first resistor is r.

4. The hybrid circuit according to claim 2, wherein
the amplification factor of the first voltage amplifier is gₘZ₀/r,
the amplification factor of the second voltage amplifier is gₘ, and
the adder outputs a voltage of 2 gₘ times a reception signal voltage Vᵣ, where the characteristic impedance of the transmission line is Z₀, the resistance value of the first resistor is r, and gₘ is a constant.

5. The hybrid circuit according to claim 1, wherein
the reception signal extraction unit comprises
a first voltage amplifier for amplifying the voltage at a connection point where the first resistor is connected to the transmission line by gₘ(1+Z₀/r) times,
a second voltage amplifier for amplifying the voltage at a connection point where the first resistor is connected to the output driver by (−gₘ Z₀/r) times, and
an adder for adding outputs of the first and second voltage amplifiers and outputting a voltage of 2 gₘ times a reception signal voltage Vᵣ, where the characteristic impedance of the transmission line is Z₀, the resistance value of the first resistor is r, and gₘ is a constant.

6. The hybrid circuit according to claim 5, wherein
the adder outputs the voltage of 2 gₘ times the reception signal voltage Vᵣ when gₘ₁=gₘ₂=gₘ as a result of adjusting both or either of gₘ₁ and gₘ₂, where the value of gₘ corresponding to the first voltage amplifier is a variable number gₘ₁ and the value of gₘ corresponding to the second voltage amplifier is a variable number gₘ₂.

7. The hybrid circuit according to claim 5, wherein
a second resistor is further inserted between the connection point where the first resistor is connected to the output driver and the second voltage amplifier.

8. The hybrid circuit according to claim 1, wherein
the reception signal extraction unit comprises
a first voltage amplifier for amplifying the voltage at a connection point where the first resistor is connected to the transmission line by gₘZ₀/r times,
a second voltage amplifier for amplifying the voltage at the connection point by gₘ times,
a third voltage amplifier for amplifying the voltage at a connection point where the first resistor is connected to the output driver by (−gₘZ₀/r) times, and
an adder for adding outputs of the first, second and third voltage amplifiers and outputting a voltage of 2 gₘ times a reception signal voltage Vᵣ, where the characteristic impedance of the transmission line is Z₀, the resistance value of the first resistor is r, and gₘ is a constant.

9. The hybrid circuit according to claim 1, wherein
the transmission line is a transmission line of a differential signal;
the first resistor is inserted serially between the output driver and the transmission line in each of a transmission path of a non-inverting signal of the differential signal and a transmission path of an inverting signal of the differential signal; and
the reception signal extraction unit comprises
a first voltage amplifier for amplifying the difference between the voltage at a connection point where the first resistor is connected to transmission line in the transmission path of the non-inverting signal and the voltage at the same connection point in the transmission path of the inverting signal by gₘ(1+Z₀/r) times,
a second voltage amplifier for amplifying the difference between the voltage at a connection point where the first resistor is connected to the output driver in the transmission path of the non-inverting signal and the voltage at the same connection point in the transmission path of the inverting signal by (−gₘZ₀/r) times, and
an adder for adding outputs of the first and second voltage amplifiers and outputting 2 gₘ times a reception signal voltage Vᵣ in the transmission paths of the non-inverting and inverting signals, where the characteristic impedance of the transmission line is Z₀, the resistance value of the first resistor is r, and gₘ is a constant.

10. The hybrid circuit according to claim 1, wherein
the transmission line is a transmission line of a differential signal;
the first resistor is inserted serially between the output driver and the transmission line in each of a transmission path of a non-inverting signal of the differential signal and a transmission path of an inverting signal of the differential signal; and
the reception signal extraction unit comprises
a first transconductance amplifier that is given, as a pair of differential inputs, the voltage at a connection point, where the first resistor is connected to the transmission line in the transmission path of the non-inverting signal, and the voltage at the same connection point in the transmission path of the inverting signal and that outputs a current corresponding to the pair of differential inputs,
a second transconductance amplifier that is given, as a pair of differential inputs, the voltage at a connection point, where the first resistor is connected to the output driver in the transmission path of the non-inverting signal, and the voltage at the same connection point in the transmission path of the inverting signal and that outputs a current corresponding to the pair of differential inputs, and
a load resistor in which flows a current of a result of adding the currents output from the first and second transconductance amplifiers.

11. The hybrid circuit according to claim 10, wherein
input time constant adjustment-use resistors for the second transconductance amplifier are connected respectively between the connection point where the first resistor is connected to the output driver in the transmission path of the non-inverting signal and a non-inverting input terminal of the second transconductance amplifier and between the connection point at the same position in the transmission path of the inverting signal and an inverting input terminal of the second transconductance amplifier.

12. The hybrid circuit according to claim 10, wherein
a resistor possessing a resistance value of Z₀−r is further connected between an output terminal of the output driver and a power supply voltage of the output driver if the impedance Z of the output driver satisfies a condition of
Z>>Z₀−r,
where the characteristic impedance of the transmission line is Z₀ and the resistance value of the first resistor is r.

13. The hybrid circuit according to claim 1, wherein
the impedance of the output driver is Z₀−r, where the characteristic impedance of the transmission line is Z₀ and the resistance value of the first resistor is r.

14. The hybrid circuit according to claim 1, wherein
a resistor possessing a resistance value of Z₀−r is further connected between an output terminal of the output driver and a power supply voltage of the output driver if the impedance Z of the output driver satisfies a condition of
Z>>Z₀−r,
where the characteristic impedance of the transmission line is Z₀ and the resistance value of the first resistor is r.

15. The hybrid circuit according to claim 1, wherein
the reception signal extraction unit comprises
a first transconductance amplifier that is given the voltages at both ends of the first resistor and that outputs a current corresponding to the input voltages,
a second transconductance amplifier that is given the voltage at a connection point, where the first resistor is connected to the transmission line, and that outputs a current corresponding to the input voltage, and
a load resistor in which flows a current of a result of adding the currents output from the first and second transconductance amplifiers.
